(19) United States
(12) Patent Application Publication
(10) Pub. No.: US 2021/0196997 A1
(43) Pub. Date: Jul. 1, 2021

(54) DISCHARGE FLOW MULTIPLICATION OF FIRE SUPPRESSION AGENT

(71) Applicant: Carrier Corporation, Palm Beach Gardens, FL (US)

(72) Inventors: Thomas Carl Kjellman, Uxbridge, MA (US); Brian Sullivan, North Granby, CT (US)

(21) Appl. No.: 17/058,488

(22) PCT Filed: Aug. 21, 2019
(86) PCT No.: PCT/US2019/047475

§ 371 Date: Nov. 24, 2020

Related U.S. Application Data
(60) Provisional application No. 62/722,588, filed on Aug. 24, 2018.

(51) Int. Cl. A62C 5/00; A62C 35/02; A62C 35/13

(52) U.S. Cl. CPC A62C 5/008; A62C 35/13; A62C 35/023

(57) ABSTRACT

A fire suppression system includes at least one spray nozzle for expelling a fire suppression agent into a space; a first container at least partially filled with a first fire suppression agent. The first fire suppression agent within the first container has a first pressure. A conduit extends from the first container to at least one spray nozzle. A second container is at least partially filled with a second fire suppression agent and is arranged in fluid communication with the conduit. The second fire suppression agent within the second container has a second pressure less than the first pressure. A mixture of the first fire suppression agent and the second fire suppression agent is movable through the conduit to the at least one spray nozzle via the first pressure.

### BACKGROUND

Embodiments of the disclosure relate generally to fire suppression systems that employ fire suppression fluids upon discharge into the air of a protected space, and more particularly to the mixing and propelling of fire extinguishing agents to a protected space.

Fire suppression systems are known, and include the use of any of a variety of fire suppressing agents that are generally discharged towards a fire. The effectiveness of a fire suppression system is dependent on multiple factors, in particular, the momentum of the expelled stream of an agent, and the rate at which the liquid portion of the agent is atomized when discharged. A typical unit in the system includes a storage container which contains a fire extinguishing agent under pressure. The storage container is usually a cylinder and often includes a valve that is connected to a control panel. The control panel can send a signal to activate a release mechanism, such as a solenoid actuator, opening the valve and releasing the fire extinguishing agent from the container. Opening the valve causes rapid dissolution of the pressurized gas from the fire suppression agent, forming a two-phase mixture (like a foam or mousse) which discharges from the valve assembly to a piping network that distributes the fire extinguishing agent to a series of interconnected nozzles placed throughout an installation, for example, in a building, where the agent is then discharged.

Each unit or storage tank of the fire suppression system typically requires a substantial amount of space, making such systems less ideal in areas of a building or installation where space is limited. Further, because typically the fire suppression agent contained within each storage tank is pressurized, the material, size and shape of the container must be selected in view of pressure considerations.

### BRIEF DESCRIPTION

According to an embodiment, a fire suppression system includes at least one spray nozzle for expelling a fire suppression agent into a space and a first container at least partially filled with a first fire suppression agent. The first fire suppression agent within the first container has a first pressure. A conduit extends from the first container to at least one spray nozzle. A second container is at least partially filled with a second fire suppression agent and is arranged in fluid communication with the conduit. The second fire suppression agent within the second container has a second pressure less than the first pressure. A mixture of the first fire suppression agent and the second fire suppression agent is movable through the conduit to the at least one spray nozzle via the first pressure.

In addition to one or more of the features described above, or as an alternative, in further embodiments the second container and the second fire suppression agent are not pressurized.

In addition to one or more of the features described above, or as an alternative, in further embodiments the first fire suppression agent has a substantially identical chemical formulation to the second fire suppression agent.

In addition to one or more of the features described above, or as an alternative, in further embodiments the first fire suppression agent has a different chemical formulation from the second fire suppression agent.

In addition to one or more of the features described above, or as an alternative, in further embodiments comprising a dip tube disposed within the second container and a venturi fitting formed in the conduit at an interface between the dip tube and the conduit.

In addition to one or more of the features described above, or as an alternative, in further embodiments a portion of the conduit is arranged within an interior of the second container.

In addition to one or more of the features described above, or as an alternative, in further embodiments the portion of the conduit arranged within the interior of the second container has at least one opening formed therein.

In addition to one or more of the features described above, or as an alternative, in further embodiments the portion of the conduit having the at least one opening is arranged near a bottom of the container.

In addition to one or more of the features described above, or as an alternative, in further embodiments the portion of the conduit having the at least one opening is defined by an eductor.

In addition to one or more of the features described above, or as an alternative, in further embodiments the portion of the conduit having the at least one opening is defined by a jet pump.

According to another embodiment, a method of delivering a fire suppression agent to a spray nozzle includes supplying a pressurized first fire suppression agent from a first container to a conduit in fluid communication with the spray nozzle, drawing a second fire suppression agent into the conduit as the first suppression agent passes through an interface between the conduit and a second container within which the second fire suppression agent is stored, and delivering a mixture of first fire suppression agent and second fire suppression agent to the spray nozzle.

In addition to one or more of the features described above, or as an alternative, in further embodiments drawing the second fire suppression agent into the conduit as the first suppression agent passes through the interface between the second container and the conduit occurs in response to a difference in pressure between the conduit and the second container.

In addition to one or more of the features described above, or as an alternative, in further embodiments the second fire suppression agent within the second container is not pressurized.

In addition to one or more of the features described above, or as an alternative, in further embodiments drawing the second fire suppression agent into the conduit as the first suppression agent passes the interface fluidly coupling the second container with the conduit includes entraining the second fire suppression agent within the first fire suppression agent.

In addition to one or more of the features described above, or as an alternative, in further embodiments the interface between the second container and the conduit includes a venturi fitting.

In addition to one or more of the features described above, or as an alternative, in further embodiments the interface between the second container and the conduit includes at least one opening formed in the conduit.

In addition to one or more of the features described above, or as an alternative, in further embodiments the interface between the second container and the conduit includes an eductor.

In addition to one or more of the features described above, or as an alternative, in further embodiments comprising opening a valve to supply the first fire suppression agent delivered from a first container to the conduit.

In addition to one or more of the features described above, or as an alternative, in further embodiments comprising detecting a fire at a fire detection sensor.

In addition to one or more of the features described above, or as an alternative, in further embodiments opening a valve to supply the first fire suppression agent delivered from a first container to the conduit occurs in response to detecting a fire at the fire detection sensor.

### BRIEF DESCRIPTION OF THE DRAWINGS

The following descriptions should not be considered limiting in any way. With reference to the accompanying drawings, like elements are numbered alike:

FIG. 1 is a schematic illustration of simplified fire suppression system for delivery a fire suppression agent according to an embodiment;

FIG. 2 is a schematic illustration of the simplified fire suppression system of FIG. 1 during operations according to an embodiment;

FIG. 3 is a schematic illustration of another simplified fire suppression system for delivery a fire suppression agent according to an embodiment; and

FIG. 4 is a schematic illustration of the simplified fire suppression system of FIG. 3 during operations according to an embodiment.

### DETAILED DESCRIPTION

A detailed description of one or more embodiments of the disclosed apparatus and method are presented herein by way of exemplification and not limitation with reference to the Figures.

Referring now to the FIGS., a fire suppression system 20 for delivering a fire suppression agent A to a space where a fire is detected is illustrated. The fire suppression system 20 includes a storage container 22. As shown, the storage container 22 is at least partially filled with a fire suppression agent A. In an embodiment, the fire suppression agent A is a liquid. However, a fire suppression agent A in another state, such as a gas for example, is also within the scope of the disclosure. A first end 26 of a dip tube 24 is arranged within the interior or the storage container 22, such as near a bottom thereof for example, and a second end 28 of the dip tube 26 is coupled to a valve 30. A conduit or pipe 32 fluidly couples the valve 30 to one or more delivery nozzles 34 such that together, the first pipe 32 and the dip tube 24 create a flow path for the fire suppression agent A from the storage container 22 to the at least one nozzle 34.

The fire suppression system 20 additionally includes at least one secondary storage container 40 containing a fire suppression agent B. In an embodiment, the fire suppression agent B in the secondary storage container 40 may be the same, i.e. have a substantially identical chemical formulation, as the fire suppression agent A stored within the first container 22. However, in other embodiments, the fire suppression agent B in one or more of the secondary storage containers 40 may be different, i.e. have a different chemical composition or formulation, than the same fire suppression agent A contained in the first container 22.

Suitable fire suppression agents useful in accordance with various embodiments of the disclosure include compounds selected from the chemical compound classes of hydrofluorocarbons, iodofluorocarbons, and fluorinated ketones. Specific hydrofluorocarbons may, but need not include, pentafluoroethane (CF₃CF₂H), 1,1,1,2-tetraflurorethane (CF₃CH₂F), 1,1,1,2,3,3,3-heptaflurorporpane (CF₃CHFCF₃), 1,1,1,2,2,3,3-heptafluoropropane (CF₃CF₂CF₂H), 1,1,1,2,2,2-hexafluoropropane (CF₃CHFCF₂H), 1,1,2,2,3,3-hexafluoropropane (HCF₂CF₂CF₂H), and 1,1,1,2,2,3-hexafluoropropane (CF₃C F₂CH₂F) for example. Exemplary iodofluorocarbons include, but are not limited to iodotrifluoromethane (CF₃I). In one embodiment, the fire suppression agent A is FK-5-1-12, 1,1,1,2,2,4,5,5,5-nonafluoro-4-(trifluoromethyl)-3-pentanone (CF₃CF₂C(═O)CF(CF₃)₂), CAS 756-13-6, often identified under the trademark Novec™ 1230, registered to 3M™ of Saint Paul, Minn.

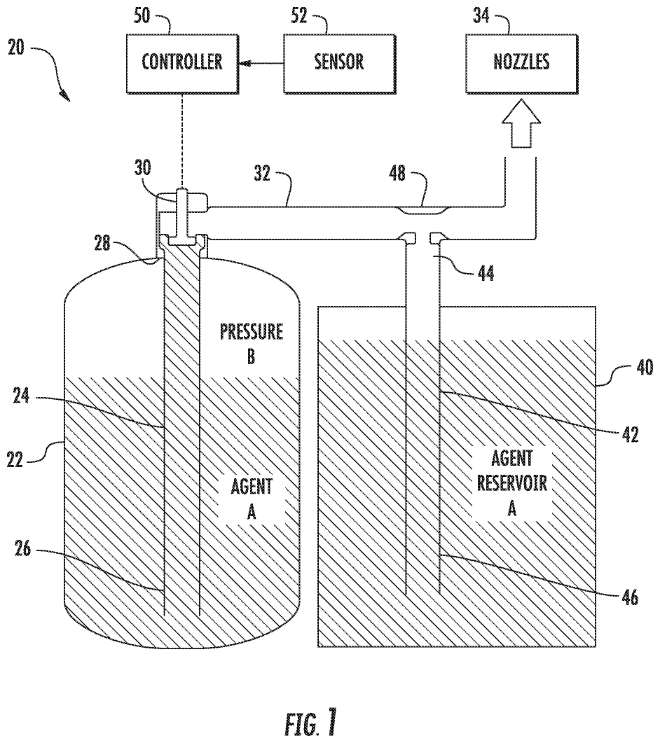

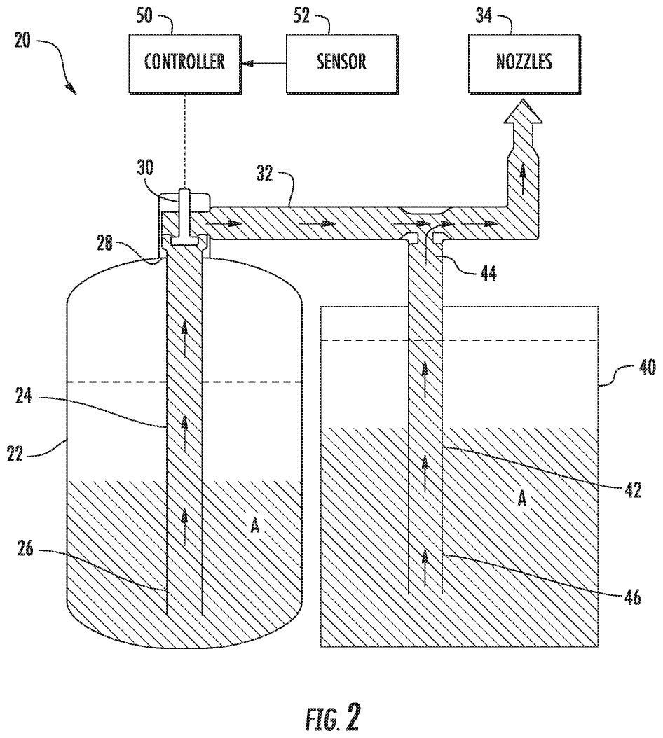

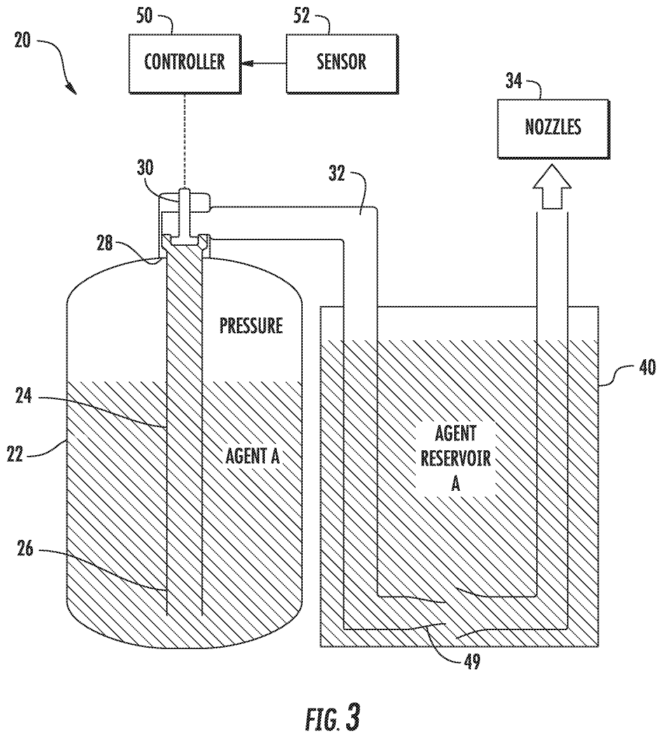

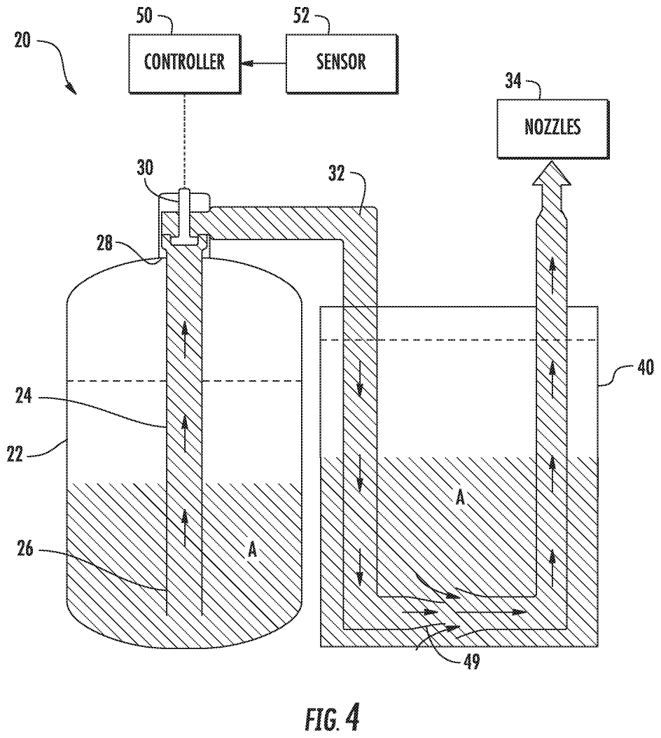

The secondary storage container 40 and the fire suppression agent B stored therein is arranged in fluid communication with the conduit 32. In an embodiment, such as shown in the non-limiting embodiment illustrated in FIGS. 1 and 2, the secondary storage container 40 includes a dip tube 42 having a first end 44 arranged in fluid communication with the conduit 32 and a second end 46 positioned within the interior of the secondary storage container 40. In such embodiments a venturi fitting 48 may be located or formed within the conduit 32 at the interface of the dip tube 42 with the conduit 32. In another embodiment, as shown in FIGS. 3 and 4, the fluid conduit 32 extends through the interior of the secondary storage container 40. Further, one or more openings or inlets 49 may be formed in the portion of the conduit 32 located within the container 40, such as near a bottom surface of the container 40 for example, such that the fire suppression agent B within the secondary storage container 40 may be provided to the fluid flow path defined by the conduit 32 via the one or more openings 49. In an embodiment, the one or more openings 49 may be defined by an eductor or jet pump formed within or coupled to the conduit 32.

A control device 50, such as a microcontroller for example, is configured to communicate with at least one fire detection device 52, such as a conventional fire detector, smoke detector or fire sensor for example, although communication with multiple fire detection devices 52 or a hazard detection system 52 that includes multiple detection devices are also within the scope of the disclosure. The fire detection device 52 may be directly connected to the control device 50, such as with a wire for example, or may be configured to communicate with the control device 50 wirelessly. The control device 50 may also be operably coupled to the valve 30 to control the flow of fire suppression agent A from the storage container 22 into the conduit 32 by controlling the degree to which the valve 30 is open or closed such that fire suppression agent A may flow through fluid conduit 32 as further described below.

When the fire suppression system 20 is inactive, the fire suppression agent A within the storage container 22 is generally pressurized with a first pressurizing gas C. In the illustrated, non-limiting embodiments, the fire suppression agent B contained within the secondary storage container 40 is not pressurized. However, in other embodiments, the fire suppression agent B contained within the one or more secondary storage containers 40 may be partially pressurized. In such embodiments, the pressure of the secondary storage containers 40 is less than the pressure of the main storage container 22.

Exemplary gases B used to pressurize the fire suppression agent A within the storage container 22 include, but are not limited to, nitrogen, argon, carbon dioxide, mixtures of these gases, or other inert gases or high vapor pressure chemicals for example. In an embodiment, pressurized gas B is at least partially dissolved into the fire suppression agent A. The storage pressure within the storage container 22 when the fire suppression system 20 is inactive is generally in the range of about 1 pound per square inch (psi) to about 250 psi. However, it should be understood that pressures of the storage container 22 outside of this range, and specifically above 250 psi are also within the scope of the disclosure. Further, embodiments where the storage container 22 is filled solely with a pressurized fluid or gas, and does not include a fire suppression agent A, are also within the scope of the disclosure.

Upon detection of a fire event by a fire detection device 52, fire suppression system 20 will activate and the control device 50 will operate valve 30 in the fire suppression system 20. Such sensing and controlling is known in the fire suppression art and is used to detect the presence of a fire and then initiate operation of the fire suppression system 20. Transformation of valve 30 to a generally open position allows the pressurized fire suppression agent A within the first canister 22 to flow freely into the conduit 32.

With reference again to FIG. 2, a flow of the pressurized fire suppression agent A travels along the fluid flow path defined by the conduit 32. The flow of the pressurized suppression agent A through the venturi fitting 48 functions as a motive flow. As the motive flow passes the end 44 of the secondary dip tube 42, the non-pressurized fire suppression agent B located within one or more of the secondary storage containers 40 becomes entrained within the pressurized flow of suppression agent A at the venturi fitting 48 for delivery to the nozzles 34. As the pressurized fire suppression agent A passes through the venturi fitting 48, a pressure drop is created across the connection to the secondary dip tube 42. By dropping the pressure in the venturi fitting 48 to lower than the pressure within the secondary tank 40, fire suppression agent B from the secondary tank 40 is drawn into and mixed with the pressurized fire suppression agent A within the venture fitting 48. Accordingly, the amount of fire suppression agent A and B provided to the nozzles 34 may be increased without increasing the amount of inert gas C necessary to drive movement of the fire suppression agent A and B through the system 20.

With reference to the embodiment of FIGS. 3 and 4, as the pressurized fire suppression agent A travels along the fluid flow path defined by the conduit 32, and specifically, the portion of the conduit 32 located within the interior of the secondary storage container 40, the pressure of the flow A draws in the fire suppression agent B through the one or more openings 49. The eductor or jet pump formed or installed within the conduit 32 includes a tapered nozzle 51. The tapered nozzle 51 is axially aligned with the conduit 32 such that the diameter of the tapered nozzle 51 becomes gradually smaller than the diameter of the conduit 32. As a result, the pressure of the fire suppression agent A increases as it passes through the tapered nozzle 51 of the eductor.

The resulting difference in pressure between the agent A within the conduit 32 and the fire suppression agent B within the secondary storage container 40, causes the non-pressurized or only partially pressurized fire suppression agent B from the secondary container 40 to be sucked into the eductor through the opening 49 and mixed with the flow of pressurized fire suppression agent A to be discharged from the eductor to the plurality of nozzles 34 downstream. Although the fire suppression system of FIGS. 1 and 2 is illustrated and described as having a venturi fitting 48 at the interface of the dip tube 42 and the conduit 32, it should be understood that the system may be alternatively be adapted to include an eductor or jet pump in place of the fitting 48. Similarly, the system illustrated and described in FIGS. 3 and 4 may incorporate a venture fitting 48 in place of the described eductor.

A fire suppression system 20 as illustrated and described herein is able to provide the same volume of fire suppression agent A to the delivery nozzles 34 using a reduced amount of pressurized inert gas required for delivery to the nozzles 34. In addition, because only the main storage container 22 is pressurized, and the secondary storage containers 40 are non-pressurized or only partially pressurized, the secondary storage containers 40 may be formed with a size and shape that is not limited by pressure considerations. Further, because the secondary storage containers 40 need not be fully or even partially pressurized, the containers 40 may be constructed more inexpensively, while maximizing the volume of storage provided by each container 40.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fire suppression system comprising:
at least one spray nozzle for expelling a fire suppression agent into a space;
a first container at least partially filled with a first fire suppression agent, wherein the first fire suppression agent within the first container has a first pressure;
a conduit extending from the first container to at least one spray nozzle;
a second container at least partially filled with a second fire suppression agent, the second container being arranged in fluid communication with the conduit, wherein the second fire suppression agent within the second container has a second pressure, the second pressure being less than the first pressure,
wherein a mixture of the first fire suppression agent and the second fire suppression agent is movable through the conduit to the at least one spray nozzle via the first pressure.

2. The fire suppression system of claim 1, wherein the second container and the second fire suppression agent are not pressurized.

3. The fire suppression system of claim 1, wherein the first fire suppression agent has a substantially identical chemical formulation to the second fire suppression agent.

4. The fire suppression system of claim 1, wherein the first fire suppression agent has a different chemical formulation from the second fire suppression agent.

5. The fire suppression system of claim 1, further comprising:
a dip tube disposed within the second container; and
a venturi fitting formed in the conduit at an interface between the dip tube and the conduit.

6. The fire suppression system of claim 1, wherein a portion of the conduit is arranged within an interior of the second container.

7. The fire suppression system of claim 1, wherein the portion of the conduit arranged within the interior of the second container has at least one opening formed therein.

8. The fire suppression system of claim 7, wherein the portion of the conduit having the at least one opening is arranged near a bottom of the container.

9. The fire suppression system of claim 7, wherein the portion of the conduit having the at least one opening is defined by an eductor.

10. The fire suppression system of claim 7, wherein the portion of the conduit having the at least one opening is defined by a jet pump.

11. A method of delivering a fire suppression agent to a spray nozzle comprising:
supplying a pressurized first fire suppression agent from a first container to a conduit in fluid communication with the spray nozzle;
drawing a second fire suppression agent into the conduit as the first suppression agent passes through an interface between the conduit and a second container within which the second fire suppression agent is stored; and
delivering a mixture of first fire suppression agent and second fire suppression agent to the spray nozzle.

12. The method of claim 11, wherein drawing the second fire suppression agent into the conduit as the first suppression agent passes through the interface between the second container and the conduit occurs in response to a difference in pressure between the conduit and the second container.

13. The method of claim 11, wherein the second fire suppression agent within the second container is not pressurized.

14. The method of claim 11, wherein drawing the second fire suppression agent into the conduit as the first suppression agent passes the interface fluidly coupling the second container with the conduit includes entraining the second fire suppression agent within the first fire suppression agent.

15. The method of claim 14, wherein the interface between the second container and the conduit includes a venturi fitting.

16. The method of claim 14, wherein the interface between the second container and the conduit includes at least one opening formed in the conduit.

17. The method of claim 16, wherein the interface between the second container and the conduit includes an eductor.

18. The method of claim 11, further comprising opening a valve to supply the first fire suppression agent delivered from a first container to the conduit.

19. The method of claim 18, further comprising detecting a fire at a fire detection sensor.

20. The method of claim 19, wherein opening a valve to supply the first fire suppression agent delivered from a first container to the conduit occurs in response to detecting a fire at the fire detection sensor.
